(19) United States
(12) Patent Application Publication
(10) Pub. No.: US 2016/0241119 A1
(43) Pub. Date: Aug. 18, 2016

(54) Vibration Component that Harvests Energy for Electronic Devices

(71) Applicant: APPLE INC., Cupertino, CA (US)

(72) Inventor: Kevin M. Keeler, Cupertino, CA (US)

(21) Appl. No.: 15/025,243

(22) PCT Filed: Sep. 27, 2013
(86) PCT No.: PCT/US2013/062254

§ 371 Date: Mar. 25, 2016

(51) Int. Cl. H02K 35/02; F03G 7/08; H02K 33/00

(52) U.S. Cl. CPC H02K 35/02; H02K 33/00; F03G 7/08

(57) ABSTRACT

An energy harvesting component for use in a portable electronic device includes a housing, a mass element within the housing, an energy transducer positioned inductively proximate the mass element, and a coupling between the mass element and the housing. In a first mode, the energy harvesting component may convert mechanical energy from agitation of the portable electronic device to electrical energy for use by the electronic device and, in a second mode, the energy harvesting component may induce movement of the mass element to provide haptic feedback.

### TECHNICAL FIELD

This disclosure relates generally to providing haptic feedback from energy harvesting components, and in particular, to techniques for providing tactile feedback from an element which harvests kinetic energy.

### BACKGROUND

Portable electronic devices are becoming increasingly prevalent as such devices gain advanced functionality and improved durability. Examples of such devices may include smart phones and tablet computers. These portable devices often include vibration elements that provide generalized tactile notifications to the user. For example, a device may associate different vibration patterns with different notification types (e.g., email, phone call).

In many cases, vibration elements must be of a certain size and mass in order to vibrate at sufficient magnitude, Due to the compact, lightweight design of many portable devices, only one vibration element is generally provided.

Portable electronic devices also include a power source. Rechargeable batteries are often used. Recently, rapid development of advanced functionality has increased power requirements at the same time market preference for compact, durable, and lightweight devices has decreased the internal volume that batteries and other components may occupy. As a result, batteries in many portable electronic devices occupy upwards of fifty percent of the interior volume of a device housing.

Consequently, power capacity has become a substantially limiting factor in the advancement of features of portable electronic devices. In many cases, a portable device must be recharged regularly for advanced functionality to be fully enjoyed. To mitigate depletion of power between recharging cycles, the battery charge may be augmented by harvesting and converting energy from various sources such as solar power, kinetic energy, or ambient electromagnetic energy. However, including energy harvesting components within existing portable electronic devices has necessitated substantial design revisions. For example, affixing a solar panel to a device encourages a user to place the device in directly sunlight, potentially resulting in undesirable thermal damage to other components within the device. In another example, some components may be decreased in size or removed entirely to accommodate the addition of an energy harvesting component, exchanging device functionality for operational longevity.

Accordingly, there may be a present need for an energy harvesting component that augments battery power in a first mode and provides advanced tactile feedback in a second mode.

### SUMMARY

Embodiments described herein may relate to or take the form of an energy harvesting component for use in a portable electronic device including a housing, a mass element positioned within the housing, an energy transducer positioned inductively proximate the mass element, and a coupling between the mass element and the housing such that the coupling defines a range of motion for the mass element with respect to the energy transducer. In a first mode, the energy transducer may convert mechanical energy from the movement of the mass element into electrical energy for use by the electronic device and, in a second mode, the energy transducer may induce movement of the mass element to provide haptic feedback.

In some embodiments, the mass element may be a magnetic field source such as a permanent magnet.

In some embodiments, the coupling may be one of a spring, a cantilever arm or a flexible elastomer. In this way, the coupling may limit the mass element to substantially rectilinear motion inductively proximate the energy transducer. In other embodiments, the coupling may be an axis about which the mass element can rotate. In this way, the coupling may limit the mass element to rotational motion inductively proximate the energy transducer.

In such an embodiment, the mass element may have its mass eccentrically distributed about the axis defined by the coupling. In this way, when operated in the second mode, the energy transducer may induce a rotation in the mass element which, due to its eccentrically distributed mass, may vibrate providing a haptic feedback.

In some embodiments, the energy transducer may be an electromagnetic coil. In certain cases, the coil may be helical, or in certain other cases, the coil may be non-helical.

In certain cases, a single energy harvesting component may include a plurality of energy transducers and a respective plurality of mass elements. Each of the plurality of mass elements may be coupled by a respective one of a plurality of couplings to a single housing or enclosure. In this case, each of the plurality of couplings may define a range of motion of its respective mass element. In some embodiments, the range of motion of an individual mass element may not necessarily interfere any other range of motion of any other respective mass element. In other words, each individual mass element may be free to move through its entire range of motion without interference from or collision any other mass element.

Embodiments described herein may also relate to or take the form of an electronic device including at least, a processor, electrical energy storage component, and a plurality of energy harvesting components electrically coupled to the processor, each component including at least an enclosure, a magnetic field source, an energy transducer positioned inductively proximate the magnetic field source, and a coupling between the magnetic field source and the enclosure. In such embodiments, the processor may be configured to selectively couple at least one of the plurality of energy harvesting components to the electrical energy storage component in order to supply electrical energy to the electrical energy storage component upon mechanical agitation of the magnetic field source. In such embodiments, the processor may also be configured to selectively supply at least one of the plurality of energy harvesting components with electrical energy to induce the respective magnetic field source to move, causing a vibratory effect.

In further embodiments, the coupling of at least one of the plurality of energy harvesting components may be a spring or a cantilever arm, which may, in some embodiments limit the magnetic field source to substantially rectilinear motion.

In some embodiments, the energy transducers may be electromagnetic coils. In certain cases, the coils may be helical, or in certain other cases, the coils may be non-helical.

In some embodiments, the electrical energy storage component may be a battery. In certain other cases, the electrical energy storage component may comprise a capacitor.

Embodiments described herein may also relate to or take the form of a method for providing haptic feedback with energy harvesting components including at least receiving a request for haptic feedback, generating a control signal based on that request, associating the control signal with an energy harvesting component which includes an interior mass, placing the energy harvesting component in a first mode so that it can receive the control signal, providing the control signal to the energy harvesting component while the component is in the first mode, inducing the at least one interior mass to vibrate in response to the control signal, and placing the energy harvesting component in a second mode to convert mechanical agitation of the at least one interior mass to electrical energy.

Some embodiments may also include receiving electrical energy from an energy harvesting component in response to mechanical agitation of an interior mass and providing received electrical energy to an electrical, storage component, such as a battery or capacitor.

Certain embodiments also include a plurality of energy harvesting components, each energy harvesting component having an interior mass. Each of the energy harvesting components may be placed in a second mode in order to convert mechanical agitation of the respective interior masses to electrical energy. The electrical energy from at least one of the plurality of energy harvesting components may be provided to the electrical energy storage component.

Embodiments described herein may also relate to or take the form of a method for providing localized haptic feedback with energy harvesting components. These methods may include at least receiving a plurality of requests for haptic feedback, generating a plurality of control signals, each control signal based on one of the plurality of requests, associating each of the plurality of control signals with one of a plurality of energy harvesting components, each of the energy harvesting components including at least one interior mass, placing the associated energy harvesting components in a first mode to receive the control signal, leaving unassociated energy harvesting components in a second mode to convert mechanical agitation of the respective at least one interior mass to electrical energy, providing each of the plurality of control signals to the respective one of the associated energy harvesting components in the first mode, inducing the respective at least one interior mass to vibrate in response to the control signal, and placing the associated energy harvesting components in a second mode to convert mechanical agitation of the at least one interior mass to electrical energy.

In some embodiments, the plurality of energy harvesting components are distributed about the interior of an electronic device such that mechanical agitation of the electronic device causes mechanical agitation of the at least one interior mass of at least one of the plurality of energy harvesting components. In such an embodiment, electrical energy may be received from at least one of the plurality of energy harvesting components. The received electrical energy may be provided to an electrical energy storage component within the electronic device.

### BRIEF DESCRIPTION OF THE DRAWINGS

Reference will now be made to representative embodiments illustrated in the accompanying figures. It should be understood that the following descriptions are not intended to limit the embodiments to one preferred embodiment. To the contrary, it is intended to cover alternatives, modifications, and equivalents as may be included within the spirit and scope of the described embodiments as defined by the appended claims.

FIG. 1 is a front elevation view of an exemplary embodiment of a portable electronic device.

FIG. 2 is an exemplary operation diagram of the portable electronic device as shown in FIG. 1.

FIG. 3 is a rear elevation view of a portable electronic device as shown in FIG. 1, showing four possible exemplary locations of energy harvesting components which may also provide haptic feedback.

FIG. 4 is an schematic side view of an exemplary embodiment of an energy harvesting component which may also provide haptic feedback.

FIG. 5A is a schematic cross section of the energy harvesting of FIG. 4 taken along line 5-5, showing an internal mass element in a rest position.

FIG. 5B is a schematic cross section of the energy harvesting of FIG. 4 taken along line 5-5, showing an internal mass element rectilinearly shifted.

FIG. 6A is an schematic cross section of an exemplary embodiment of an energy harvesting component which may also provide haptic feedback, showing an internal mass element suspended in a rest position via cantilever arm within a coil portion.

FIG. 6B is a schematic cross section of the exemplary embodiment of FIG. 6A, showing the internal mass element displaced within the coil portion at a positive angle about an arc defined by deflection of the cantilever arm.

FIG. 7 is a representative flow chart of a process of process of providing haptic feedback with energy harvesting components.

### DETAILED DESCRIPTION

Various embodiments of an energy harvesting component suitable to inclusion within a portable electronic device to augment battery power in a first mode, while providing advanced tactile feedback in a second mode, are discussed herein. In certain embodiments, an energy harvesting component may include an enclosure, a moving mass, a magnetic field source, an electromagnetic coil, and a spring.

In select embodiments, the spring may be coupled to the moving mass and to the enclosure so as to define an axis along which the moving mass may displace within the enclosure. In certain cases, the magnetic field source may be coupled to the moving mass.

In these embodiments, the spring, moving mass, and magnetic field source may be positioned inductively proximate the electromagnetic coil.

In certain embodiments, the moving mass may be displaced along the axis defined by the spring, which may cause the spring to briefly compress or expand about its equilibrium position before exerting a restoring force sufficient to retract or advance the moving mass back to equilibrium. This in turn may initiate a brief oscillation of the moving mass about the equilibrium point. The initial displacement and subsequent oscillation of the moving mass may cause the magnetic field of the coupled magnetic field source to induce an electrical current within the electromagnetic coil. This current may then be provided to a circuit for charging a battery. In this way, the energy harvesting component may operate as a linear alternator.

In other embodiments, the moving mass may be rotatable about an axis defined by the coupling to be inductively proximate the electromagnetic coil. In such an embodiment, the mass element may have its mass eccentrically distributed about the axis defined by the coupling such that when energy harvesting component is rotated or otherwise mechanically agitated, the eccentric mass will rotate, which may cause the magnetic field of the coupled magnetic field source to induce an electrical current within the electromagnetic coil. This current may then be provided to a circuit for charging a battery. In this way, the energy harvesting component may operate as a rotational alternator. When operated in the second mode, the electromagnetic coil may be supplied with a current which in turn may induce a rotation in the mass element which, due to its eccentrically distributed mass, may vibrate providing a haptic feedback.

In further embodiments, the moving mass may be continuously agitated by an external force, such as by shaking the energy harvesting component. In this case, the oscillation of the moving mass may cause the coupled magnetic field source to induce an electrical current which may then be provided to a circuit for charging a battery.

In certain embodiments, an alternating current may be applied to the electromagnetic coil, inducing a magnetic field of alternating polarity. The induced magnetic field may alternately attract or repel the magnetic field source. This may cause the moving mass to displace, which may in turn cause the coupled spring to compress or expand about its equilibrium point before exerting a restoring force sufficient to retract or advance the moving mass back to equilibrium. At particular frequencies, the alternating polarity magnetic field may cause a resonance effect such that the moving mass perceivably vibrates. In this way, the energy harvesting component may operate as a linear resonance actuator.

In certain embodiments, a pulsed direct current may be applied to the electromagnetic coil, inducing a magnetic field upon application of each pulse. The induced magnetic field may either attract or repel the magnetic field source, which may cause the moving mass to displace, which may in turn cause the coupled spring to compress or expand about its equilibrium point before exerting a restoring force sufficient to retract or advance the moving mass back to equilibrium. At particular frequencies the pulsing magnetic field, in conjunction with the restoring force exerted by the spring, may cause the moving mass to perceivably vibrate.

In alternate embodiments, the magnetic field source may be coupled to the housing and the electromagnetic coil may be coupled to the moving mass.

In further embodiments, multiple energy harvesting components may be distributed along the interior of a portable electronic device. In certain cases, each harvesting component may be placed in a first mode, such that each component is capturing energy and augmenting the battery charge. In other embodiments, the multiple energy harvesting components may be placed in a second mode such that each component is providing tactile feedback via controlled oscillation of each respective moving mass.

In certain embodiments related to the second mode, vibrations of several energy harvesting components may be synchronized. In such a case, the moving mass elements of each component may vibrate in unison. In certain other embodiments related to the second mode, different elements may provide different frequencies of vibration, magnitudes of vibration, patterns of vibration, or any combination thereof. These different vibrations may interact constructively or destructively to provide a specialized tactile feedback to the user.

In further embodiments, only a single energy harvesting component may be active in a second mode, so as to provide tactile feedback at a specific location about the surface of the portable electronic device. Other energy harvesting components may be left in the first mode.

In certain embodiments, elements not placed in a second mode may be placed in a third mode. The third mode may consist of temporarily preventing the motion of the movable mass element. In such a case, a constant direct current may be applied to the electromagnetic coil in order to induce a constant magnetic field which either attracts or repels the magnetic field source, such that the magnetic field source and moving mass are substantially stationary. The third mode may be activated such that vibrations provided by an energy harvesting device in a second mode are not attenuated or absorbed by an energy harvesting component otherwise set in a first mode.

In further embodiments, a portable electronic device may dynamically switch the mode of multiple energy harvesting components. In certain cases, a processor or other circuitry may be electrically coupled to each energy harvesting component. In certain cases, the processor may switch the mode of an energy harvesting component if the device is determined to be in motion. For example, if a sensor (e.g., inertial measurement unit, accelerometer, global positioning sensor, or gyroscope) determines that a device is in motion, a processor may connect energy harvesting components to trickle charging circuitry. In another example, if a processor determines that the device is not in motion, the processor may disconnect the energy harvesting element entirely, placing the element in an idle fourth mode.

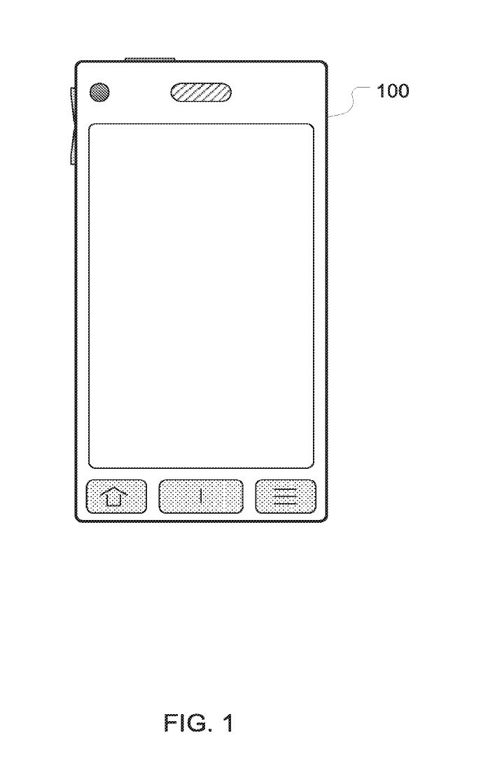

FIG. 1 is a front elevation view of an exemplary embodiment of a portable electronic device, FIG. 1 shows a portable cellular telephone as portable electronic device 100, although it may be appreciated that FIG. 1 is meant to be an example only, and other electronic devices may incorporate embodiments set forth herein, or may be such embodiments. For example, tablet computing devices, input/output devices such as keyboards and mice, wearable devices, peripherals, and the like all may be or incorporate embodiments disclosed herein.

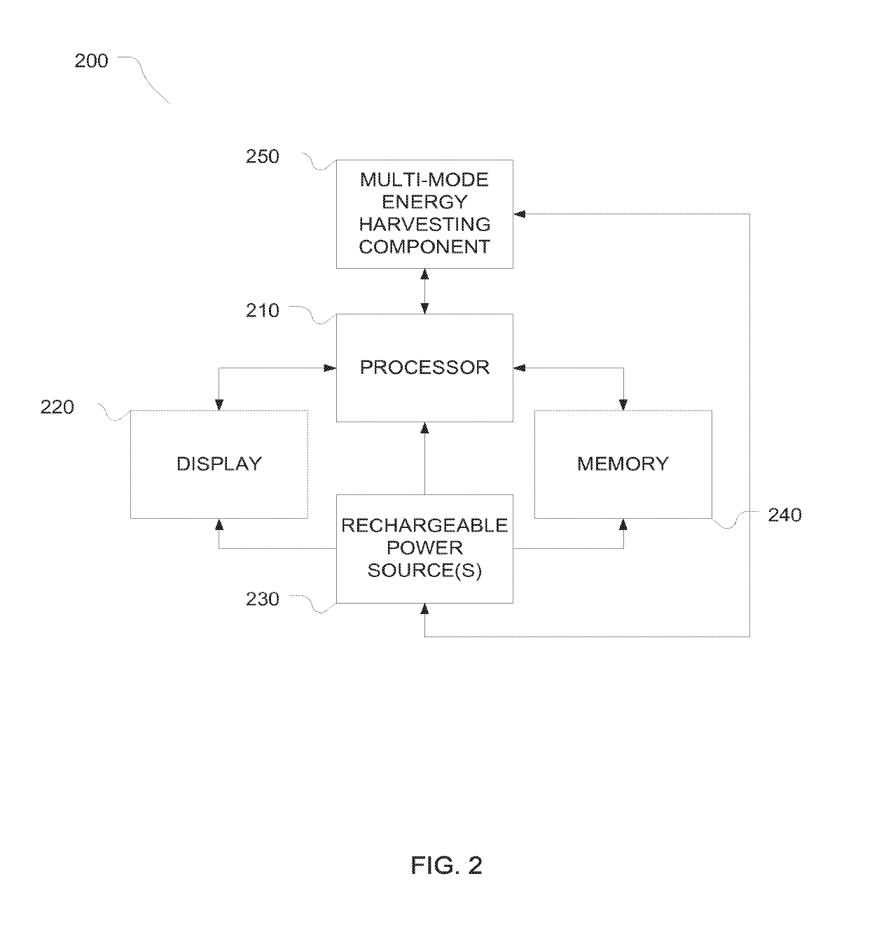

FIG. 2 is an exemplary operation diagram of the portable electronic device 200 of FIG. 1. The device 200 may include a processor 210, a rechargeable power source 230, a memory 240, and at least one multi-mode energy harvesting component 250. The processor 210 is in signal communication with the energy harvesting component 250, the display 230 and the memory 240, and may be provided with a combination of firmware and software to perform additional functions including, but not limited to, voice communications, messaging, media playback and development, gaming, internet access, navigational services, and personal digital assistant functions including reminders, alarms, and calendar tasks.

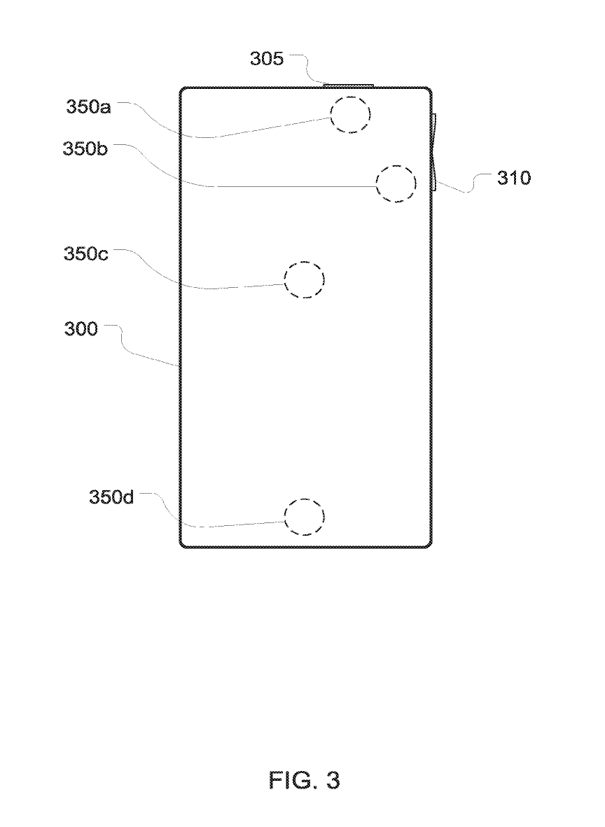

FIG. 3 is an isometric rear view of the portable electronic device 300 of FIG. 1, showing four possible exemplary locations of the energy harvesting components 350a-d, Although illustrated along the back of the portable electronic device 300, one may appreciate that the energy harvesting components 350a-d may be located anywhere within the housing of electronic device 300. Further, it may be appreciated that more or less than four energy harvesting components 350a-d may be present. One may also appreciate that the size of the energy harvesting components 350a-d may be substantially smaller than shown in relation to the housing of portable electronic device 300. For example, in certain embodiments, the energy harvesting component may be constructed as a portion of a microelectromechanical system (“MEMS”). In such a case, millions of individual energy harvesting components may be present within the housing of the electronic device 300.

An energy harvesting component 350a may be located proximate a physical button 305. In certain embodiments, the energy harvesting component 350a may be agitated every time a user presses the physical button 305. Similarly, an energy harvesting component 350b may be located proximate another physical button 310. An energy harvesting component 350c may be centrally located within the portable electronic device 300. An energy harvesting component 350d may be centrally located along the bottom of the portable electronic device 300.

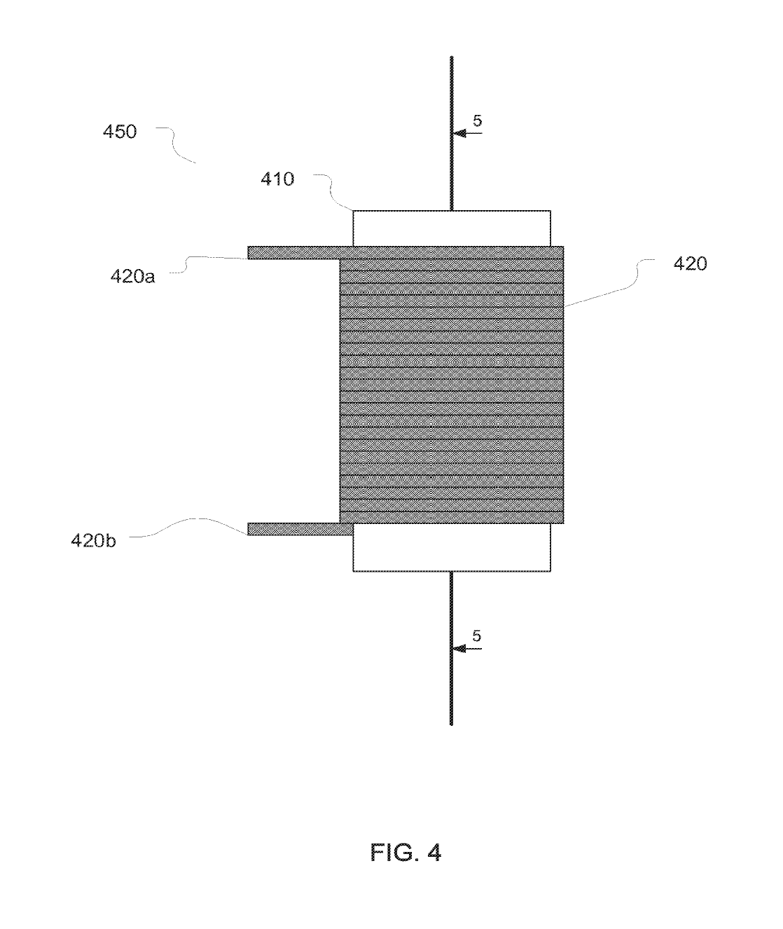

FIG. 4 is a schematic view of an exemplary embodiment of an energy harvesting component 450 which may also provide haptic feedback. Shown are a housing 410 and an electromagnetic coil 420. The electromagnetic coil may act as a current loop, which may end in two terminal leads 420a and 420b. The electromagnetic coil 420 is shown wrapped about the hollow housing 410 in a single-layer substantially helical pattern, but one may appreciate that other patterns may be appropriate. For example, the electromagnetic coil 420 may in some embodiments include multiple wiring layers. The housing 410 may be constructed of any suitable material. In certain embodiments, the housing may be constructed of plastic with a low electromagnetic permeability.

In certain embodiments, the energy harvesting component 450 may be a surface mounted device (“SMD”). In such an embodiment, the terminals 420a and 420b may be present on opposite ends of the housing 410.

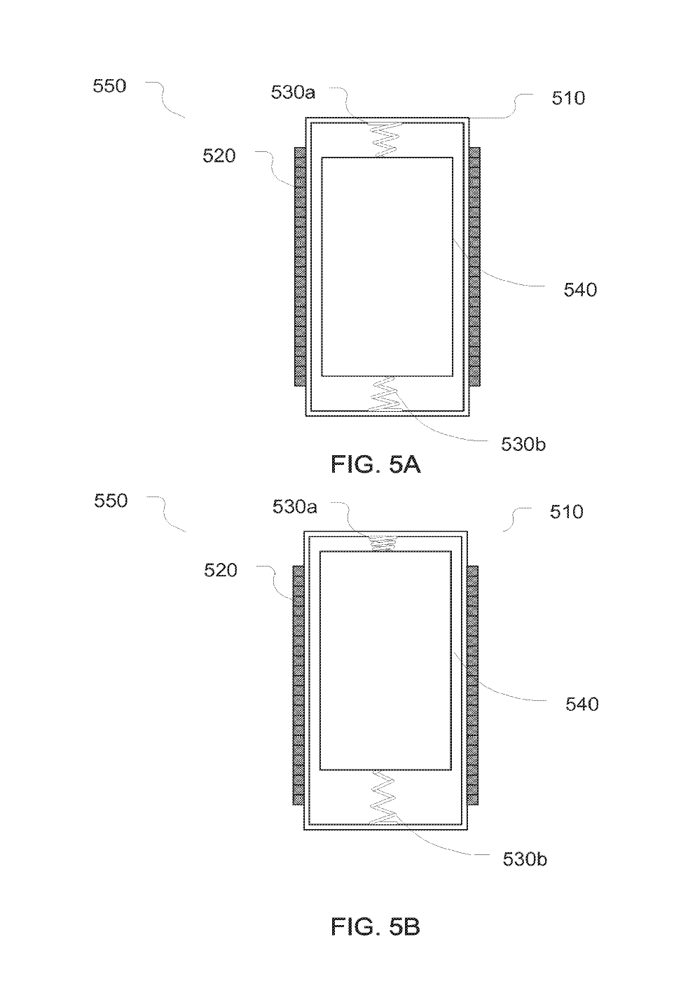

FIG. 5A is a cross section of the energy harvesting component 550 of FIG. 4 taken along line 5-5, showing an internal mass element in a rest position. Shown are the housing 510, an enclosed internal mass element 540, and spring elements 530a, 530b. In certain embodiments, the internal mass element 540 may comprise a magnetic field source. An exemplary magnetic field source may be a permanent magnet such as a neodymium magnet. In certain other embodiments, multiple permanent magnets may be aligned to additively combine to a single magnetic field source. In further embodiments, the internal mass element 540 may be magnetically inert. In such a case, the element may be coupled with or otherwise adhered to a permanent magnetic field source. In another embodiment, an electromagnetically inert internal mass element may be dipped or otherwise coated in a material providing a magnetic field source. In certain further embodiments, the internal mass element may comprise another electromagnetic coil that provides a magnetic field source when connected to an electrical power source.

As shown, the spring elements 530a-b are partially extended beyond their equilibrium point. In this way, when the internal mass element 540 is deflected upward (relative to the illustration) by an agitating force, the spring element 530a may compress and the spring element 530b may extend, each providing a partial restoring force (expansive and compressive, respectively) to the mass element 540, as shown in FIG. 5B. Inversely, when the internal mass element 540 is deflected downward by an agitating force, the spring element 530b may compress and the spring element 530a may extend, each providing a partial restoring force to the mass element 540.

Returning to FIG. 5A, the spring elements 530a, 530b may be fixedly coupled to the housing 510 and to opposite ends of mass element 540. As noted, in some embodiments, the internal mass element 540 may be a permanent magnet or other magnetic field source. In such a case, the distance between the electromagnetic coil 520 and magnetized internal mass element 540 directly impacts efficiency of both energy harvesting and tactile feedback. Although shown at a particular distance separated, it may be appreciated that the internal mass element 540 may be separated by a greater or lesser distance suitable for electromagnetic induction.

In an alternate embodiment, a direct current may be applied to electromagnetic coil 520. In such a case, a magnetic field may be created. In response to the magnetic field created by the electromagnetic coil 520, the magnetic field source associated with the internal mass element 520 may rectilinearly move as the respective magnetic fields repel one another. For example, FIG. 5B may also represent a deflection of the internal mass element 540 after a direct current has been applied.

In certain other embodiments, an alternating current may be applied to the electromagnetic coil 520. In such a case, a magnetic field of alternating polarity may be created. In response to the magnetic field created by the electromagnetic coil 520, the magnetic field source associated with the internal mass element 520 may rectilinearly shift as the respective fields repel one another, causing one of the spring elements 530a, 530b to compress. Once the magnetic field created by the electromagnetic coil 520 changes its polarity, the magnetic field source associated with the internal mass element may rectilinearly repel to the opposite end of the housing 510, causing the opposite spring to compress. At an appropriate frequency of alternating current, the internal mass element 520 may vibrate. In this way, the energy harvesting component may also provide haptic feedback. One may appreciate that alternating current when applied to the electromagnetic coil 520 may take any number of waveforms. In certain embodiments a sinusoidal waveform may be used. At an appropriate frequency of alternating current, the internal mass element 520 may vibrate. In this way, the energy harvesting component may also provide haptic feedback.

In certain other embodiments, a switched direct current may be applied to the electromagnetic coil 520. In such a case, a magnetic field may be created when current is supplied to the coil. In response to the magnetic field created by the electromagnetic coil 520, the magnetic field source associated with the internal mass element 520 may rectilinearly shift as the respective fields repel one another. When the direct current is switched off, restoring forces within spring elements 530a, 530b as described above, may cause the internal mass element 540 to restore to its equilibrium position. In this manner, the internal mass element 520 may vibrate.

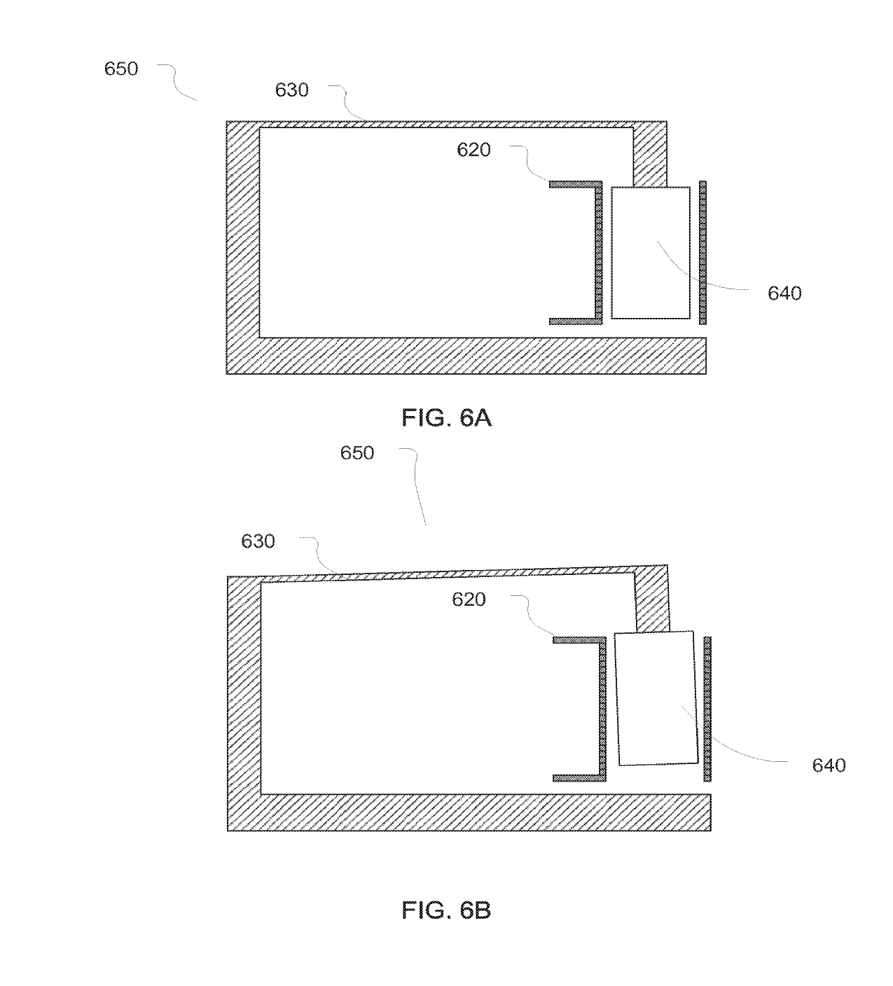

FIG. 6A is a schematic cross section of an exemplary embodiment of an energy harvesting component 650 which may also provide haptic feedback, showing an internal mass element 640, which may include a magnetic field source, suspended in a rest position via cantilever arm 630 within a coil portion 640. One may appreciate that the embodiment of FIG. 6A is functionally similar to the embodiment as shown in FIGS. 5A-5B in that the spring element 530 has been replaced by the cantilever arm 630. When an agitating force is applied to move the energy harvesting component 650, the internal mass element may shift. However, the range of motion that the cantilever arm 630 defines is different from that in FIGS. 5A-5B. As shown in FIG. 6B, a cross section of the exemplary embodiment of FIG. 6A, the internal mass element may be displaced within the coil portion at an angle of an arc defined by bend or deflection of the cantilever arm. One may appreciate that the cantilever arm may bend or deflect about an arc downward.

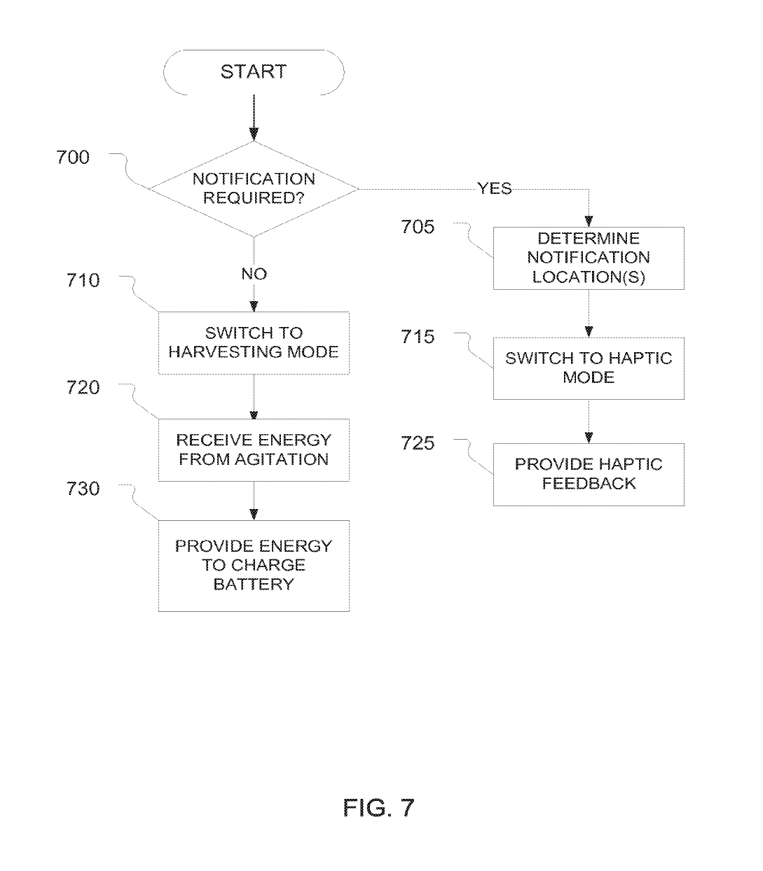

FIG. 7 is a representative flow chart of a process of process of providing haptic feedback with energy harvesting components. First, a notification state may be determined at step 700. The notification state may be based on whether a notification is required. For example, in certain embodiments, the notification state may be binary in that either a notification is required, or a notification is not required.

If a notification is not required, providing haptic feedback may not be necessary. An energy harvesting component may be placed in a harvesting mode at step 710. Once in a harvesting mode, an energy harvesting component may receive energy from agitation at step 720. Energy received may then be used to charge battery at step 730.

In the alternative, if a notification is required, providing haptic feedback is necessary. First, notification locations may be determined at step 705. Next, energy harvesting components that are determined to be within locations associated with the required notification may be placed in a haptic feedback mode at step 715. Once in a haptic feedback mode, an energy harvesting component may provide haptic feedback to the user.

One may appreciate that although many embodiments are disclosed above, that the operations presented in FIG. 7 are meant as exemplary and accordingly are not exhaustive. One may further appreciate that alternate step order or additional or fewer steps may be used to accomplish the same method.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments but is instead defined by the claims herein presented.

We claim:

1. An energy harvesting component for use in a portable electronic device comprising:
a housing;
a mass element positioned within the housing;
an energy transducer positioned inductively proximate the mass element; and
a coupling between the mass element and the housing; wherein:
in a first mode the energy transducer converts mechanical energy from movement of the mass element into electrical energy for use by the portable electronic device; and
in a second mode the energy transducer induces movement of the mass element to cause a vibratory effect in the device.

2. The energy harvesting component of claim 1, wherein the mass element comprises a magnetic field source.

3. The energy harvesting component of claim 1, wherein the coupling comprises one of a spring or a cantilever arm.

4. The energy harvesting component of claim 1, wherein the energy transducer comprises an electromagnetic coil.

5. The energy harvesting component of claim 1, wherein the coupling limits the mass element to substantially rectilinear motion.

6. The energy harvesting component of claim 1, wherein the coupling limits the mass element to rotational motion.

7. The energy harvesting component of claim 1, wherein the energy harvesting component comprises a plurality of energy transducers and a plurality of mass elements.

8. The energy harvesting component of claim 7, wherein each of the plurality of mass elements is coupled by a respective one of a plurality of couplings to a housing; and
each of the plurality of couplings defines a range of motion of the respective mass element; wherein:
the respective range of motion of a respective mass element does not interfere with any other respective range of motion of any other respective mass element.

9. An electronic device comprising;
a processor;
a plurality of energy harvesting components electrically coupled to the processor, each component comprising:
an enclosure;
a magnetic field source;
an energy transducer positioned inductively proximate the magnetic field source; and
a coupling between the magnetic field source and the enclosure; and
an electrical energy storage component; wherein:
the processor is configured to selectively couple at least one of the plurality of energy harvesting components to the electrical energy storage component in order to supply electrical energy to the electrical energy storage component; and
the processor is configured to selectively supply at least one of the plurality of energy harvesting components with electrical energy to induce the respective magnetic field source to move to cause a vibratory effect in the device.

10. The electronic device of claim 9, wherein the coupling of at least one of e plurality of energy harvesting components comprises a spring or a cantilever arm.

11. The electronic device of claim 9, wherein the energy transducer of at least one of the plurality of energy harvesting components comprises an electromagnetic coil.

12. The electronic device of claim 9, wherein the coupling of at least one of the plurality of energy harvesting components limits the magnetic field source to substantially rectilinear motion.

13. The electronic device of claim 9, wherein the electrical energy storage component comprises a battery.

14. A method for providing haptic feedback with energy harvesting components comprising:
receiving a request for haptic feedback;
generating a control signal based on the request;
associating the control signal with a first energy harvesting component having an interior mass;
placing the first energy harvesting component in a first mode to receive the control signal;
providing the control signal to the first energy harvesting component in the first mode, inducing the interior mass to vibrate in response to the control signal; and
placing the first energy harvesting component in a second mode to convert mechanical agitation of the interior mass to electrical energy.

15. The method of claim 14, further comprising receiving electrical energy from the first energy harvesting component in response to mechanical agitation of the interior mass; and
providing received electrical energy to an electrical energy storage component.

16. The method of claim 15, further comprising a plurality of energy harvesting components, each energy harvesting component having a respective interior mass.

17. The method of claim 16, further comprising placing each of the plurality of energy harvesting components in a second mode to convert mechanical agitation of each respective interior mass to electrical energy;
receiving electrical energy from at least one of the plurality of energy harvesting components; and
providing received electrical energy to the electrical energy storage component.

18. A method for providing localized haptic feedback with energy harvesting components comprising:
receiving a plurality of request for haptic feedback;
generating a plurality of control signals, each control signal based on one of the plurality of requests;
associating each of the plurality of control signals with a respective one of a plurality of energy harvesting components, each of the energy harvesting components including a respective interior mass;
placing the associated energy harvesting components in a first mode to receive the associated control signals, leaving unassociated energy harvesting components in a second mode to convert mechanical agitation of the respective interior mass to electrical energy;
providing the associated control signals to the respective associated energy harvesting components in the first mode, inducing each respective interior mass to vibrate in response to the control signal; and
placing the associated energy harvesting components in a second mode to convert mechanical agitation of each respective interior mass to electrical energy.

19. The method of claim 18, wherein the plurality of energy harvesting components is distributed about the interior of an electronic device; and
mechanical agitation of the electronic device causes mechanical agitation o the respective interior mass of one or more of the plurality of energy harvesting components.

20. The method of claim 19, further comprising
receiving electrical energy from one or more of the plurality of energy harvesting components; and
providing received electrical energy to an electrical energy storage component within the electronic device.
